(19) United States
(12) Patent Application Publication
(10) Pub. No.: US 2024/0310640 A1
(43) Pub. Date: Sep. 19, 2024

(54) HEAD-MOUNTED DISPLAY

(71) Applicant: SONY GROUP CORPORATION, TOKYO (JP)

(72) Inventors: NORIHIRO KATO, TOKYO (JP); TATSUYA SAKAI, TOKYO (JP)

(21) Appl. No.: 18/261,488

(22) PCT Filed: Dec. 20, 2021
(86) PCT No.: PCT/JP2021/046902

§ 371 Date: Jul. 14, 2023

(30) Foreign Application Priority Data
Jan. 22, 2021 (JP) 2021-008706

(51) Int. Cl. G02B 27/01

(52) U.S. Cl. CPC G02B 27/0176; G02B 27/0172; G02B 2027/0141; G02B 2027/0143; G02B 2027/0154; G02B 2027/0178

(57) ABSTRACT

To provide a head-mounted display capable of finely adjusting a position of a display in a left-right direction. The present technology provides a head-mounted display including an optical plate that is arranged in front of an eyeball of a user and causes image display light to reach the eyeball. The optical plate is pivotable in a left-right direction about a center of the eyeball as a pivot center. The head-mounted display of the present technology may be a monocular type.

### TECHNICAL FIELD

The present technology relates to a head-mounted display.

### BACKGROUND ART

A head-mounted display used by being mounted on a head portion of a user is known. The head-mounted display is roughly divided into a binocular type in which a display is viewed with both eyes and a monocular type in which a display is viewed with one eye. The monocular head-mounted display displays an image on a display arranged in front of one eye of the user. The display is generally an optical see-through type, and can transmit light from the outside world. Therefore, the user can visually recognize both a scene of the outside world and an image in the display.

However, for example, when the scene of the outside world and the image in the display overlap with each other, visibility of the scene of the outside world and/or the image in the display may be reduced. Furthermore, for example, there is a case where the scene and the image that the user wants to view at the same time are at distant positions in a field of view, and it is difficult to view both at the same time, or the eyes are fatigued even if both can be viewed at the same time. In order to eliminate such low visibility, the user is preferably able to freely move a position of the image.

One way to move the position of the image is to adjust a position of the display. Conventionally, various head-mounted displays capable of adjusting the position of the display have been proposed. For example, Patent Document 1 below discloses a head-mounted display. The head-mounted display includes a pivotable support member and a box supported by a distal end of the support member via a hinge joint, and a small display device is accommodated in the box. The box is positioned at a position facing the user's eyes by adjusting a pivot angle of the support member and/or by adjusting a bending angle of the hinge joint. Furthermore, Patent Document 2 below discloses a head-mounted display. The head-mounted display may include a mounting tool, an arm connected to the mounting tool, and an image display unit movably supported by the arm. The head-mounted display may include a first ball joint capable of rotating the arm and a second ball joint capable of rotating the image display unit, and a position of the image display unit may be freely adjusted by these ball joints.

### CITATION LIST

### Patent Documents

Patent Document 1: Japanese Patent Application Laid-Open No. H6-54370
Patent Document 2: Japanese Patent Application Laid-Open No. 2016-127500

### SUMMARY OF THE INVENTION

### Problems to be Solved by the Invention

However, in the head-mounted display disclosed in Patent Document 1 described above, it is difficult to finely adjust the position of the display, and it is particularly difficult for the user to finely adjust the display in a left-right direction. Furthermore, in the head-mounted display disclosed in Patent Document 2 described above, the user can freely adjust the position of the display, but it is difficult to say that fine adjustment can be easily performed.

Therefore, a main object of the present technology is to provide a head-mounted display capable of finely adjusting a position of a display in a left-right direction.

### Solutions to Problems

That is, the present technology provides a head-mounted display including an optical plate that is arranged in front of an eyeball of a user and causes image display light to reach the eyeball, in which the optical plate is pivotable in the left-right direction about a center of the eyeball as a pivot center.

The optical plate may be further pivotable in an up-down direction about a center of the eyeball as a pivot center.

The optical plate may be further movable in at least one direction among a left-right direction, an up-down direction, and a front-back direction with respect to the eyeball.

The head-mounted display may include a flexible frame to be mounted on a head portion of the user, and the frame may be mounted in a circumferential direction of the head portion over a right temporal region, an occipital region, a left temporal region, and at least one of a right frontal region or a left frontal region of the user.

The image display light may form a character image corresponding to spoken voice of a speaker, and the optical plate may be configured to allow the user to visually recognize the speaker.

The head-mounted display may be used for hearing assistance.

The head-mounted display may be the monocular type.

### BRIEF DESCRIPTION OF DRAWINGS

FIG. 1 is a perspective view of a monocular head-mounted display.

FIG. 2 is a perspective view of an image display device.

FIG. 3 is a perspective view of an optical module.

FIG. 4 is an exploded perspective view of the optical module.

FIG. 5 is a schematic view for explaining an operation of the optical module.

FIG. 6 is a plan view of a user wearing the monocular head-mounted display as viewed from above.

FIG. 7 is a perspective view of the user wearing the monocular head-mounted display as viewed from left front.

FIG. 8 is a perspective view of the user wearing the monocular head-mounted display as viewed from right front.

FIG. 9 is a plan view of the user wearing the monocular head-mounted display as viewed from above.

FIG. 10 is a perspective view of the user wearing the monocular head-mounted display as viewed from left front.

FIG. 11 is a perspective view of the user wearing the monocular head-mounted display as viewed from right front.

FIG. 12 is a perspective view of the user wearing the monocular head-mounted display as viewed from obliquely above in front.

FIG. 13 is a perspective view of the user wearing the monocular head-mounted display as viewed from obliquely above in front.

FIG. 14 is a perspective view of the user wearing the monocular head-mounted display as viewed from obliquely above in front.

FIG. 15 is a view illustrating an example of an overall configuration of a character image display system.

FIG. 16 is a view illustrating an example of an overall configuration of the character image display system.

FIG. 17 is a perspective view of a monocular head-mounted display of a first modification.

FIG. 18 is a front view of the monocular head-mounted display of the first modification.

FIG. 19 is a rear view of the monocular head-mounted display of the first modification.

FIG. 20 is a left side view of the monocular head-mounted display of the first modification.

FIG. 21 is a right side view of the monocular head-mounted display of the first modification.

FIG. 22 is a plan view of the monocular head-mounted display of the first modification.

FIG. 23 is a bottom view of the monocular head-mounted display of the first modification.

FIG. 24 is a reference top view illustrating a state in which the monocular head-mounted display of the first modification is folded.

FIG. 25 is a perspective view of a monocular head-mounted display of a second modification.

FIG. 26 is a front view of the monocular head-mounted display of the second modification.

FIG. 27 is a rear view of the monocular head-mounted display of the second modification.

FIG. 28 is a left side view of the monocular head-mounted display of the second modification.

FIG. 29 is a right side view of the monocular head-mounted display of the second modification.

FIG. 30 is a plan view of the monocular head-mounted display of the second modification.

FIG. 31 is a bottom view of the monocular head-mounted display of the second modification.

FIG. 32 is a reference top view illustrating a state in which the monocular head-mounted display of the second modification is folded.

### MODE FOR CARRYING OUT THE INVENTION

Hereinafter, preferred modes for carrying out the present technology will be described with reference to the drawings. The embodiments described below illustrate representative embodiments of the present technology, and the scope of the present technology is not limited only to these embodiments. The present technology will be described in the following order.
1. First embodiment (head-mounted display)
   (1) Configuration of head-mounted display
   (2) Configuration of image display device
   (3) Configuration of optical module
   (4) Operation of optical module
   (5) Position adjustment mechanism of image display device
   (6) Shape of frame
2. Second embodiment (character image display system)
   (1) System overview
   (2) System configuration and operation
3. Modification
   (1) First modification
   (2) Second modification

Note that, in the present specification, a monocular head-mounted display may be referred to as a “head-mounted display” by omitting the term “monocular”.

Furthermore, in the present specification, in a case where a front direction in which a face of a user wearing the head-mounted display of the present technology faces is a front direction, a “left-right direction”, an “up-down direction”, and a “front-back direction” respectively mean a left-right direction of the face, an up-down direction of the face, and a front-back direction of the face.

### 1. First Embodiment (Head-Mounted Display)

### (1) Configuration of Head-Mounted Display

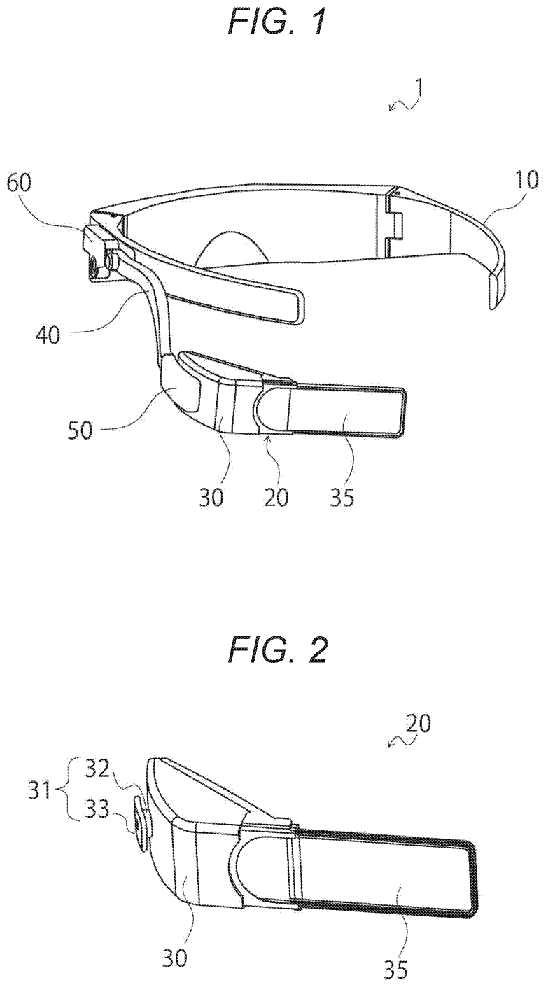

A head-mounted display according to a first embodiment of the present technology will be described. In general, head-mounted displays include a binocular type in which a display is viewed with both eyes and a monocular type in which a display is viewed with one eye. The head-mounted display of the present embodiment may be the binocular type or the monocular type, but a case of the monocular type will be described below as an example. First, with reference to FIG. 1, an outline of a configuration of a monocular head-mounted display 1 will be described. FIG. 1 is a perspective view of the monocular head-mounted display 1. The head-mounted display 1 may include a frame 10, an image display device 20, and a holding member 40.

The frame 10 is a flexible member to be mounted on a head portion of the user. The frame 10 may include one or a plurality of members. By forming one or a plurality of members constituting the frame 10 with a flexible material, flexibility is given to the frame 10. Since the frame 10 has flexibility, the frame 10 can be easily attached to, detached from, and fixed to the head portion of the user.

The image display device 20 accommodates an optical module including an image generation unit and an optical plate to be described later. The image display device 20 may include a housing 30 and a display unit 35. The housing 30 accommodates the image generation unit, and the display unit 35 accommodates the optical plate. Details of a configuration of the image display device 20 will be described later.

The holding member 40 is a member that is attached to the frame 10 and holds the image display device 20. The holding member 40 may have, for example, a configuration in which one end portion is connected to the image display device 20 and another end portion is attached to the frame 10. For example, as illustrated in FIG. 1, one end portion of the holding member 40 may be connected to the housing 30 of the image display device 20 at a connecting portion 50, and another end portion of the holding member 40 may be attached to a position corresponding to a temporal region in the frame 10 in a mounting portion 60.

The head-mounted display 1 can include a position adjustment mechanism for the image display device 20. As a result, the image display device 20 is configured to be position-adjustable and position-holdable. That is, the holding member 40 is configured to hold the image display device 20 so that the position of the image display device 20 can be adjusted and held. Details of the position adjustment mechanism of the image display device 20 will be described later.

### (2) Configuration of Image Display Device

A configuration of the image display device 20 will be described with reference to FIG. 2. FIG. 2 is a perspective view of the image display device 20.

The image display device 20 illustrated in FIG. 2 is a device for accommodating the optical module to be described later and displaying an image visually recognized by the user. The image display device 20 can include, for example, the housing 30 and the display unit 35.

The housing 30 accommodates an image generation unit of the optical module to be described later. As illustrated in FIG. 2, the housing 30 may include, for example, a connecting member 31. The connecting member 31 is a member for causing the housing 30 and the holding member 40 to be connected at the connecting portion 50 (see FIG. 1). The connecting member 31 may include, for example, a shaft portion 32 and a head portion 33.

The display unit 35 accommodates an optical plate of the optical module described later. The display unit 35 corresponds to a so-called display, and is arranged in front of an eyeball on one side (that is, the right eyeball or the left eyeball) of the user at the time of using the head-mounted display 1 of the present embodiment. As a result, the optical plate accommodated in the display unit 35 is also arranged in front of the eyeball on one side of the user. The display unit 35 may be an optical see-through type display capable of transmitting light from the outside world. Since the display unit 35 is of the optical see-through type, the user can visually recognize both a scene of the outside world and an image displayed on the display unit 35.

### (3) Configuration of Optical Module

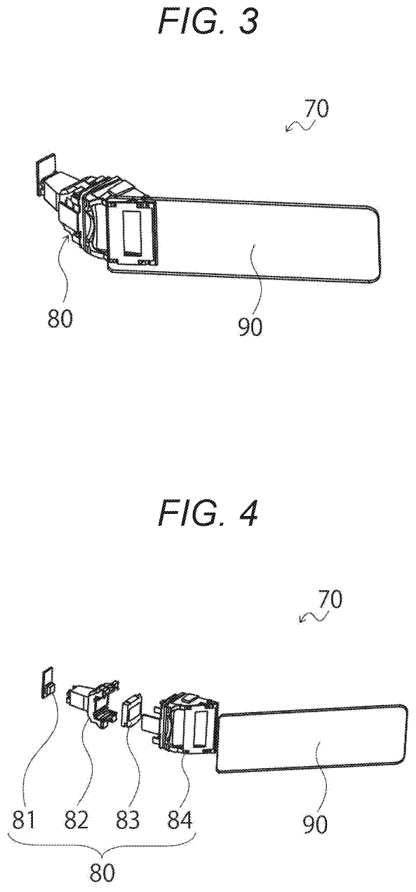

A configuration of an optical module 70 will be described with reference to FIGS. 3 and 4. FIG. 3 is a perspective view of the optical module 70. FIG. 4 is an exploded perspective view of the optical module 70.

The optical module 70 may include, for example, an image generation unit 80 and a light guide plate 90. The image generation unit 80 is accommodated in the housing 30 of the image display device 20 illustrated in FIG. 2. The light guide plate 90 is accommodated in the display unit 35 of the image display device 20 illustrated in FIG. 2. The light guide plate 90 is an example of the optical plate in the head-mounted display of the present technology.

The image generation unit 80 illustrated in FIG. 4 includes a light source 81, an illumination tube 82, a microdisplay 83, and a projection lens system 84. The light source 81 may be, for example, an LED. The projection lens system 84 may include, for example, an aperture and a collimator lens. Light emitted from the light source 81 passes through the illumination tube 82, the microdisplay 83, the projection lens system 84, and the light guide plate 90, and finally reaches the user's eyeball as image display light.

### (4) Operation of Optical Module

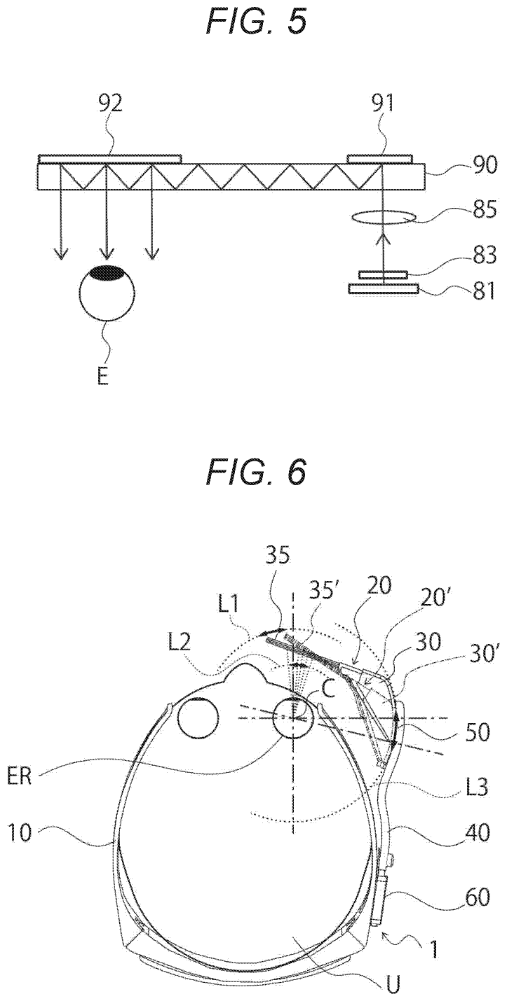

An operation of the optical module 70 will be described with reference to FIG. 5. FIG. 5 is a schematic view for explaining an operation of the optical module 70. The light guide plate 90 illustrated in FIG. 5 includes an incident hologram 91 and an emission hologram 92 on a surface thereof.

The microdisplay 83 optically processes light emitted from the light source 81 to form image display light, and emits the image display light toward a collimator lens 85. The collimator lens 85 collimates the image display light emitted from the microdisplay 83. The collimated image display light reaches the light guide plate 90. The incident hologram 91 on the light guide plate 90 diffuses the image display light incident on the light guide plate 90, and causes the image display light to travel to an inside of the light guide plate 90. The emission hologram 92 on the light guide plate 90 diffuses the image display light traveling inside the light guide plate 90, and causes the image display light to be emitted from the light guide plate 90 to reach an eyeball E of the user.

The emission of the image display light described above can be controlled by, for example, a control unit (not illustrated). That is, the head-mounted display 1 may include the control unit that controls emission of the image display light.

The control unit described above can control various operations of the head-mounted display 1, including control of emission of the image display light. The control unit may include, for example, a processor and a memory. The processor may be, for example, a central processing unit (CPU) or the like, and executes a program stored in a memory. The memory may be, for example, a read only memory (ROM), a random access memory (RAM), or the like, and may store a program to be executed by the processor. The control unit may further include various components used for controlling an operation of the head-mounted display 1, such as, for example, a storage, a communication interface, and a drive. The storage may be, for example, a flash memory or the like, and may store a control program such as a program for realizing emission of the image display light, and a program and data related to an operation of the head-mounted display 1, such as image data. The communication interface is a communication interface for performing wired or wireless communication with an external device. The drive is, for example, a reader for a removable recording medium, and may read, for example, a program and/or image data recorded in a removable recording medium such as a microSD memory card and an SD memory card, and output to the RAM.

An image formed by the image display light may be formed on the basis of data acquired from an external device (for example, a mobile terminal or a server device) that is connected to the head-mounted display 1 to be able to communicate with the head-mounted display 1 in a wired or wireless manner. Furthermore, the image formed by the image display light may be formed on the basis of data stored in a storage installed on the head-mounted display 1, a removable recording medium, or the like.

### (5) Position Adjustment Mechanism of Image Display Device

A position adjustment mechanism of the image display device in the head-mounted display of the present technology will be described. In the head-mounted display, the image display device is configured to be position-adjustable and position-holdable. The image display device may include the display unit that internally accommodates the optical plate as described above, and the display unit moves in synchronization with movement of the image display device. Therefore, in the head-mounted display of the present technology, the display unit and the optical plate accommodated in the display unit are also configured to be position-adjustable and position-holdable.

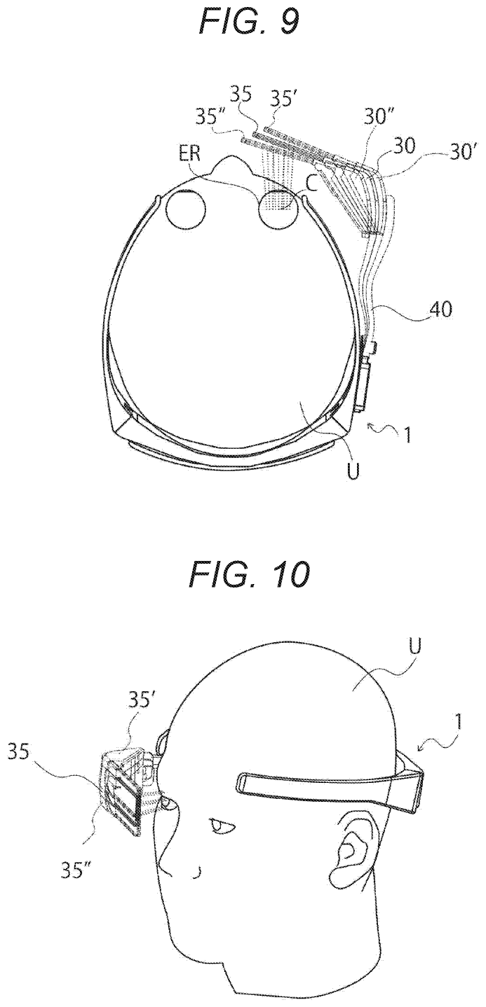

In the head-mounted display of the present technology, specifically, a position of the optical plate described above is finely adjustable in the left-right direction. Moreover, the position of the optical plate may be finely adjustable in the up-down direction, and adjustment other than these fine adjustments may be possible. Hereinafter, movement and position adjustment of the optical plate will be described with reference to FIGS. 6 to 11. First, with reference to FIGS. 6 to 8, a case will be described in which a position of the optical plate is finely adjusted in the left-right direction and the up-down direction. Next, with reference to FIGS. 9 to 11, a case will be described in which the position of the optical plate is further moved. Note that, in the following, movement and position adjustment of the display unit of the image display device will be described for convenience of the drawings. However, it should be understood that the description is also the description of movement and position adjustment of the optical plate since the movement of the optical plate is the same as the movement of the display unit.

### (5-1) Fine Adjustment in Left-Right Direction

First, with reference to FIG. 6, a case will be described in which a position of the display unit is finely adjusted in the left-right direction. FIG. 6 is a plan view of a user U wearing the monocular head-mounted display 1 as viewed from above.

As illustrated in FIG. 6, the frame 10 of the head-mounted display 1 is mounted on a head portion of the user U. One end portion of the holding member 40 is attached to the frame 10, at the mounting portion 60 provided at a position corresponding to a right temporal region in the frame 10. Another end portion of the holding member 40 is connected to the housing 30 of the image display device 20 at the connecting portion 50. The display unit 35 of the image display device 20 is arranged in front of a right eyeball ER of the user U.

The position of the display unit 35 described above can be finely adjusted in the left-right direction. In the present specification, the fine adjustment of the position of the display unit 35 means that the position of the display unit is adjusted by pivoting about a center of an eyeball of the user as a pivot center. That is, the display unit 35 illustrated in FIG. 6 is pivotable in the left-right direction about a center C of the eyeball ER as a pivot center. In other words, the display unit 35 is pivotable in the left-right direction along an arc centered on the center C of the eyeball ER. Broken lines L1 and L2 in FIG. 6 are arcs centered on the center C of the eyeball ER, and schematically indicate trajectories that can be taken when the display unit 35 pivots in the left-right direction. The display unit 35 can be stopped at any position determined by the user after pivoting in the left-right direction, and is held at the stopped position. The display unit 35′ illustrated in FIG. 6 represents a state after the display unit 35 pivots rightward about the center C of the eyeball ER as the pivot center.

Here, advantages brought about by the fine adjustment described above will be described. A range in which a person can see without moving the eyes when gazing at one point (a gaze point) of the outside world is referred to as a field of view. Even if an effective field of view is close to 180 degrees, a discriminative field of view in which characters and the like can be recognized is in a range of about 5 degrees from the gaze point. Therefore, in order for a person to simultaneously see two objects without moving the eyes, the two objects need to be present within the range of 5 degrees of vision. For example, at the time of wearing a general optical see-through type head-mounted display, when a specific scene of the outside world and an image in the display that the user wants to see at the same time are overlapped with each other in the field of view, there is a case where it is desired to move a position of the image to the right or left without deviating from the field of view. Furthermore, when a specific scene of the outside world and an image in the display that the user wants to see at the same time are at distant positions at the time of wearing the general display, there is a case where it is desired to move the image to the right or the left such that the image enters the field of view, while setting the specific scene of the outside world at the center of the field of view. In such a case, it is preferable to be able to finely adjust the position of the display on which the image is displayed to the right or the left without changing the position of the specific scene of the outside world existing in the field of view.

In the head-mounted display of the present technology, the display unit (that is, a so-called display) is pivotable in the left-right direction about a center of the user's eyeball as a pivot center. Therefore, in the case described above, the head-mounted display of the present technology can finely adjust the position of the display unit to left and right while setting the specific scene of the outside world described above at the center of the field of view. This configuration makes it possible to move the position of the image without changing the position of the scene of the outside world in the field of view. As a result, it is possible to simultaneously visually recognize the specific scene of the outside world and the image in the display unit without moving the eyes.

As described above, in the present technology, the fact that the position of the display unit can be finely adjusted in the left-right direction provides an advantage of being able to finely adjust the position of the image displayed on the display unit in the left-right direction, without changing the position of the scene of the outside world visually recognized by the user.

With reference to FIG. 6 again, the head-mounted display 1 of the present embodiment will be described. In order to finely adjust the position of the display unit 35 of the image display device 20 in the left-right direction and hold the finely adjusted position, for example, the housing 30 of the image display device 20 may be connected to one end portion of the holding member 40 at the connecting portion 50 so as to be slidable in an arc shape and position-holdable. A broken line L3 in FIG. 6 is an arc centered on the center C of the eyeball ER. For example, at the connecting portion 50, the housing 30 may be connected to one end portion of the holding member 40 so as to be slidable along an arc centered on the center of the eyeball as indicated by a broken line L3 and to be position-holdable. Specifically, a configuration may be adopted in which, for example, at the connecting portion 50, the housing 30 of the image display device 20 comes into slidable surface contact with one end portion of the holding member 40 in a state of being brought into pressure contact, and both a contact surface of the housing 30 and a contact surface of the holding member 40 may be formed in an arc shape. As a result, the housing 30 can pivot with an appropriate frictional force with respect to the holding member 40, and can stop at any position determined by the user and hold the position. For example, the contact surface of the housing 30 and the contact surface of the holding member 40 may be formed along an arc (for example, the arc indicated by the broken line L3) centered on a center of the eyeball in plan view.

### (5-2) Fine Adjustment in Up-Down Direction

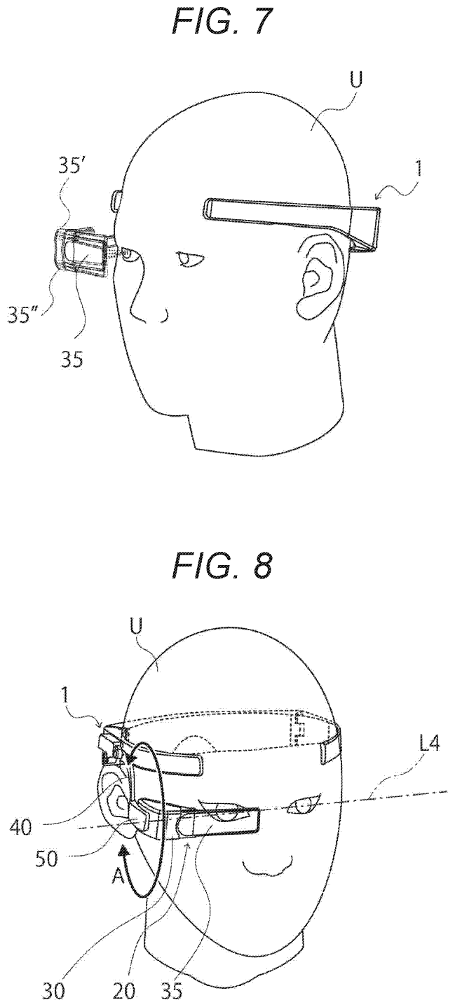

Next, with reference to FIG. 7, a case will be described in which a position of the display unit is finely adjusted in the up-down direction. FIG. 7 is a perspective view of the user U wearing the monocular head-mounted display 1 as viewed from left front.

The display unit 35 illustrated in FIG. 7 can finely adjust a position in the up-down direction. That is, the display unit 35 is pivotable in the up-down direction about a center of an eyeball of the user U as a pivot center. In other words, the display unit 35 is pivotable in the up-down direction along an arc centered on the center of the eyeball. The display unit 35 can stop at any position determined by the user after pivoting in the up-down direction, and is held at the stopped position. The display unit 35′ illustrated in FIG. 7 represents a state after the display unit 35 pivots in an upward direction about the center of the eyeball as the pivot center. The display unit 35″ illustrated in FIG. 7 represents a state after the display unit 35 similarly pivots in a downward direction.

Advantages brought about by the fine adjustment in the up-down direction are similar to the advantages described above in “(5-1) Fine adjustment in left-right direction” described above. That is, in the present technology, the fact that the position of the display unit 35 can be finely adjusted in the up-down direction provides an advantage of being able to finely adjust a position of the image displayed on the display unit 35 in the up-down direction, without changing a position of the scene of the outside world visually recognized by the user.

In order to finely adjust the position of the display unit 35 in the up-down direction and hold the finely adjusted position, for example, a configuration illustrated in FIG. 8 may be adopted. FIG. 8 is a perspective view of the user U wearing the monocular head-mounted display 1 as viewed from right front. A one-dot chain line L4 in FIG. 8 indicates a straight line passing through centers of the right and left eyeballs of the user U. For example, a configuration may be adopted in which the connecting portion 50 includes a first pivot shaft (for example, the one-dot chain line L4) whose axis is a linear direction passing through the right and left eyeball centers of the user U, and the housing 30 of the image display device 20 may be supported by the first pivot shaft to pivot in a direction of an arrow A with respect to the holding member 40. As a result, the display unit 35 of the image display device 20 may be configured to be pivotable in the up-down direction about the center of the eyeball of the user as the pivot center, and to be able to stop at any position determined by the user to hold the position.

Furthermore, in order to enable the fine adjustment in the up-down direction and the fine adjustment in the left-right direction described in (5-1) described above, for example, the configuration of the image display device 20 illustrated in FIG. 2 may be adopted. The housing 30 of the image display device 20 illustrated in FIG. 2 includes the connecting member 31 having the shaft portion 32 and the head portion 33. The connecting member 31 constitutes the connecting portion 50 illustrated in FIG. 1, and is a member connected to one end portion of the holding member 40. Although not illustrated, for example, one end portion of the holding member 40 may include a groove portion, and the groove portion and the connecting member 31 may be connected at the connecting portion 50. Specifically, for example, at the connecting portion 50, the head portion 33 and the groove portion may be fitted such that the head portion 33 of the connecting member 31 is slidable with respect to the groove portion of the holding member 40 and is pivotable about a center of the shaft portion 32 as a pivot center.

The fine adjustment of the display unit 35 in the left-right direction and the up-down direction has been described above with reference to FIGS. 6 to 8 and the like. The display unit 35 illustrated in FIGS. 6 to 8 is arranged in front of the right eyeball of the user U, but the arrangement of the display unit 35 is not limited thereto. That is, the display unit 35 may be arranged in front of the left eyeball of the user U. Even in a case where the display unit 35 is arranged in front of the left eyeball, movement and position adjustment of the display unit 35 are as described above.

### (5-3) Movement in Left-Right Direction, Up-Down Direction, and Front-Back Direction

Next, a case will be described in which a position of the display unit is moved in the left-right direction, the up-down direction, and the front-back direction. In the head-mounted display of the present technology, the display unit (including the optical plate) can be configured to be movable in at least one direction among the up-down direction, the left-right direction, and the front-back direction with respect to the eyeball.

First, with reference to FIG. 9, a case where the position of the display unit 35 is moved in the left-right direction will be described. FIG. 9 is a plan view of the user U wearing the monocular head-mounted display 1 as viewed from above.

The display unit 35 illustrated in FIG. 9 can move in the left-right direction with respect to the right eyeball ER of the user U. Note that the movement in the left-right direction does not include a pivot in the left-right direction about the center C of the eyeball ER as the pivot center, which has been described with reference to FIG. 6 in “(5-1) Fine adjustment in left-right direction” described above. The display unit 35 illustrated in FIG. 9 can be stopped at any position determined by the user after moving in the left-right direction, and is held at the stopped position. A display unit 35′ illustrated in FIG. 9 represents a state after the display unit 35 moves in the right direction, and a display unit 35″ represents a state after the display unit 35 moves in the left direction.

Next, with reference to FIG. 10, a case where the position of the display unit 35 is moved in the up-down direction will be described. FIG. 10 is a perspective view of the user U wearing the monocular head-mounted display 1 as viewed from left front.

The display unit 35 illustrated in FIG. 10 is movable in the up-down direction with respect to the eyeball of the user U. Note that the movement in the up-down direction does not include a pivot in the up-down direction about the center of the eyeball as the pivot center, which has been described with reference to FIG. 7 in “(5-2) Fine adjustment in up-down direction” described above. The display unit 35 illustrated in FIG. 10 can stop at any position determined by the user after moving in the up-down direction, and is held at the stopped position. A display unit 35′ illustrated in FIG. 10 represents a state after the display unit 35 moves in the upward direction, and a display unit 35″ represents a state after the display unit 35 moves in the downward direction.

A face width and an eye width of the user U described above are different from person to person, and a position where the display unit 35 is arranged may also be different from person to person at the time of wearing the head-mounted display 1. In a case where the display unit 35 is not arranged at a position in front of the eyeball where it is easy to visually recognize, it is necessary for the user U to move the position of the display unit 35 to left and right and/or up and down. Since the display unit 35 is configured to be movable in the left-right direction and/or the up-down direction as described above, the user U can arrange the display unit 35 at an appropriate position in front of the eyeball.

Although not illustrated, the display unit may be movable in the front-back direction with respect to the eyeball of the user. For example, in a case where the user wears the head-mounted display of the present technology on glasses, it is preferable that the display is arranged on a front side of a lens of the glasses. With the configuration in which the display unit is movable in the front-back direction in the head-mounted display of the present technology, the user can arrange the display unit at an appropriate position even in a case where the user wears glasses.

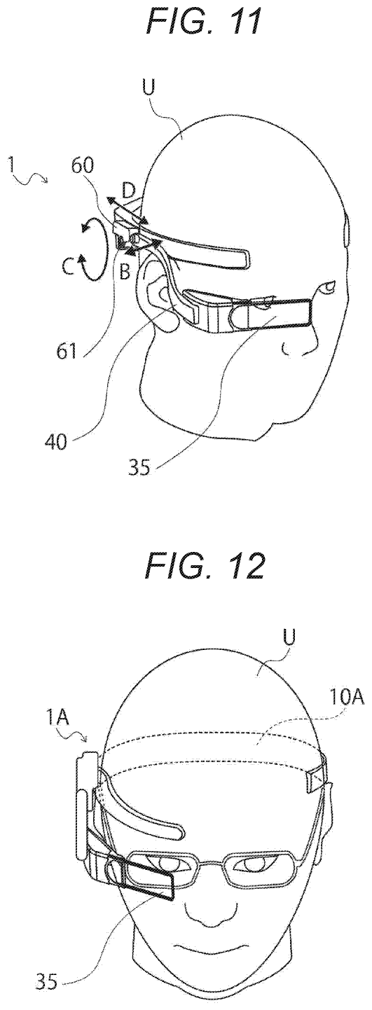

FIG. 11 is a perspective view of the user U wearing the monocular head-mounted display 1 as viewed from right front. For example, the holding member 40 may be configured to move in a direction of an arrow B at the mounting portion 60 and to be able to stop at any position determined by the user such that the display unit 35 is movable in the left-right direction with respect to the eyeball and is position-holdable. For example, the holding member 40 may be configured to pivot in a direction of an arrow C with a second pivot shaft 61 as an axis and to be able to stop at any position determined by the user such that the display unit 35 is movable in the up-down direction with respect to the eyeball and is position-holdable. For example, the holding member 40 may be configured to be able to move in a direction of an arrow D at the mounting portion 60 and stop at any position determined by the user such that the display unit 35 is movable in the front-back direction with respect to the eyeball and is position-holdable.

The display unit 35 illustrated in FIGS. 9 to 11 described above is arranged in front of the right eyeball of the user U, but may be arranged in front of the left eyeball. Even in a case where the display unit 35 is arranged in front of the left eyeball, the movement of the display unit 35 in the left-right, up-down, and front-back directions is as described above.

### (6) Shape of Frame

An example of a shape of a frame used for the head-mounted display of the present technology will be described with reference to FIG. 12. FIG. 12 is a perspective view of the user U wearing a monocular head-mounted display 1A as viewed from obliquely above in front. In the head-mounted display 1A of the present technology, a frame 10A may be mounted in a circumferential direction of a head portion over a right temporal region, an occipital region, a left temporal region, and at least one of a right frontal region or a left frontal region of the user U. The frame 10A illustrated in FIG. 12 is mounted in the circumferential direction of the head portion over the right frontal region, the right temporal region, the occipital region, and the left temporal region of the user U. The display unit 35 is movable downward by deeply mounting the frame 10A to the head portion, and the display unit 35 is movable upward by shallowly mounting the frame 10A. Therefore, even if there is no configuration in which the display unit is movable in the up-down direction as described in (5-3) above, for example, the position of the display unit 35 can be moved up and down depending on a mounting state of the frame 10A.

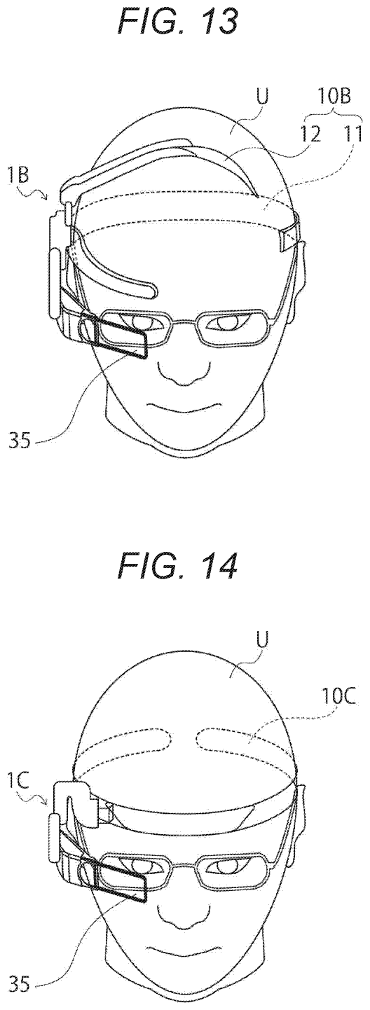

Another example of a shape of the frame will be described with reference to FIG. 13. FIG. 13 is a perspective view of the user U wearing a monocular head-mounted display 1B as viewed from obliquely above in front. The head-mounted display 1B includes a frame 10B. The frame 10B includes a first frame member 11 and a second frame member 12. The first frame member 11 is a member to be mounted in a circumferential direction of the head portion over the right frontal region, the right temporal region, the occipital region, and the left temporal region of the user U. The second frame member 12 is a member to be mounted from a portion of the first frame member 11 corresponding to the right temporal region to a top portion. In the frame 10B, the head portion can be pressed from the circumferential direction by the first frame member 11, and the head portion can be pressed from a direction orthogonal to the circumferential direction by the second frame member 12. Therefore, the frame 10B has an advantage that slipping off is less likely to occur as compared with a frame that holds only the circumferential direction.

Another example of a shape of the frame will be described with reference to FIG. 14. FIG. 14 is a perspective view of the user U wearing a monocular head-mounted display 1C as viewed from obliquely above in front. The head-mounted display 1C includes a frame 10C. The frame 10C has a C-shape in which a part of an annular shape is cut out when viewed from above, and is mounted in the circumferential direction of the head portion such that the cut portion is located on the occipital region of the user U. That is, the frame 10C is mounted in the circumferential direction of the head portion over the occipital region except for the part, both temporal regions, and the frontal region. The display unit 35 is movable in the left-right direction by moving the frame 10C in the circumferential direction of the head portion. Therefore, even if there is no configuration in which the display unit is movable in the left-right direction as described in (5-3) above, for example, the position of the display unit 35 can be moved to left and right by moving the frame 10C in the circumferential direction of the head portion.

Although a case of the monocular type has been described as an example of the head-mounted display of the present technology, the head-mounted display of the present technology may be the binocular type. Therefore, the configuration of the monocular head-mounted display described in the first embodiment described above can be applied to a binocular head-mounted display. In a case of the binocular head-mounted display, for example, the image display device described above is configured to cause image display light to reach both eyeballs of the user. For example, the binocular head-mounted display may include two of the image display devices described above, and one image display device may be arranged in front of the eyeball of the right eye, and another image display device may be arranged in front of the eyeball of the left eye.

### 2. Second Embodiment (Character Image Display System)

A character image display system according to a second embodiment of the present technology will be described.

### (1) System Overview

An outline of the character image display system described above will be described. This system includes a head-mounted display of the present technology, and is a system that causes a display unit (an optical plate) of the head-mounted display to display a character image corresponding to spoken voice of a speaker. The display unit (the optical plate) of the above-described head-mounted display used in this system is an optical see-through type in which a user visually recognizes a character image and can also visually recognize a scene of the outside world at the same time. That is, the display unit (the optical plate) of the head-mounted display is configured to allow the user to visually recognize the speaker described above. Therefore, the user wearing the head-mounted display can visually recognize a figure of the speaker and a character image corresponding to spoken voice of the speaker at the same time.

### (2) System Configuration and Operation

First, with reference to FIG. 15, an overall configuration of a character image display system 100 according to the second embodiment will be described. FIG. 15 is a view illustrating an example of an overall configuration of the character image display system 100. The character image display system 100 illustrated in FIG. 1 includes a monocular head-mounted display 1, a mobile terminal 200, an electrical unit 300, and an information processing apparatus 400. The electrical unit 300 is connected to the head-mounted display 1 by a cable 500, and is also connected to the mobile terminal 200 by a cable 600.

The head-mounted display 1 can be the head-mounted display according to the first embodiment of the present technology described in 1. above.

The mobile terminal 200 is a portable computer device having a voice acquisition function and a communication function. The mobile terminal 200 has a function of acquiring spoken voice of a speaker, a function of communicating with the information processing apparatus 400, and the like. The mobile terminal 200 may be, for example, a mobile phone, a smartphone, a tablet terminal, or the like. A hardware configuration of the mobile terminal 200 may be similar to that of a general computer device. The mobile terminal 200 may include, as an example, a processor, a memory, a microphone, a communication interface, an input device, and an output device. The microphone is used to acquire voice and converts the voice into an audio signal. The communication interface is an interface for communication with other devices. Basically, the functions of the mobile terminal 200 are implemented by the processor executing a predetermined control program stored in the memory.

The electrical unit 300 may include, for example, a control board and a power source. The control board may include, for example, a processor such as a central processing unit (CPU) and a memory such as a read only memory (ROM) and a random access memory (RAM). For example, the control board has a function of transmitting character image data received from the mobile terminal 200 to the head-mounted display 1. The power source is, for example, a storage battery, and supplies power to each component of the head-mounted display 1.

The information processing apparatus 400 is a computer apparatus having a communication function, and can be, for example, a server apparatus (particularly, a cloud server). The information processing apparatus 400 stores, for example, information of character image data corresponding to an audio signal, and has a function of receiving an audio signal from another apparatus and transmitting character image data corresponding to the audio signal to the another apparatus. A hardware configuration of the information processing apparatus 400 can be similar to that of a general computer device having a communication function. As an example, the information processing apparatus 400 can include a processor, a memory, a communication interface, an input device, and an output device. The functions of the information processing apparatus 400 are basically implemented by the processor executing a predetermined control program stored in the memory.

Next, an operation of the character image display system 100 will be described. A user who uses the character image display system 100 is a user who wears the head-mounted display 1 on a head portion and has the mobile terminal 200, and faces a speaker. The mobile terminal 200 acquires spoken voice of the speaker and converts the spoken voice into an audio signal. The mobile terminal 200 acquires character image data corresponding to the audio signal from the information processing apparatus 400, and transmits the character image data to the head-mounted display 1 via the electrical unit 300. The head-mounted display 1 processes the received character image data to generate image display light for forming a character image corresponding to the spoken voice of the speaker described above. As a result, the character image corresponding to the spoken voice of the speaker described above is displayed on the display unit of the head-mounted display 1.

For example, when a scene of an outside view superimposed on the character image includes various colors or patterns, it may be difficult for the user to visually recognize the character image described above. In this case, as described in 1. above, the user can freely move the display unit of the head-mounted display 1 to a position where the character image is easily visually recognized, by changing the position of the display unit.

The head-mounted display included in the character image display system of the present embodiment is particularly suitable for hearing assistance. Since this system can display spoken voice of a speaker as character information on the head-mounted display, the user wearing the head-mounted display can visually supplement speech information of the speaker.

In order to understand speech contents of the speaker, a deafness person may look at the mouth of the speaker and read spoken words from movement of the mouth. Therefore, in a case where the character image display system described above is used for the purpose of hearing assistance, it is preferable that a character image corresponding to spoken voice can be displayed near the mouth of the speaker so that the user can more accurately understand the speech contents of the speaker. That is, it is preferable that the user can visually recognize the mouth of the speaker and the character image at the same time. In the head-mounted display used in the character image display system of the present embodiment, as described above, a position of a character image is moved while a scene of the outside world is placed at a center, and both the scene of the outside world and the character image can be adjusted to fall within a field of view. By using the character image display system, the user who needs hearing assistance can visually recognize the mouth of the speaker and a character image corresponding to spoken voice of the speaker at the same time without moving the eyes, so that it is easier to understand the speech information of the speaker.

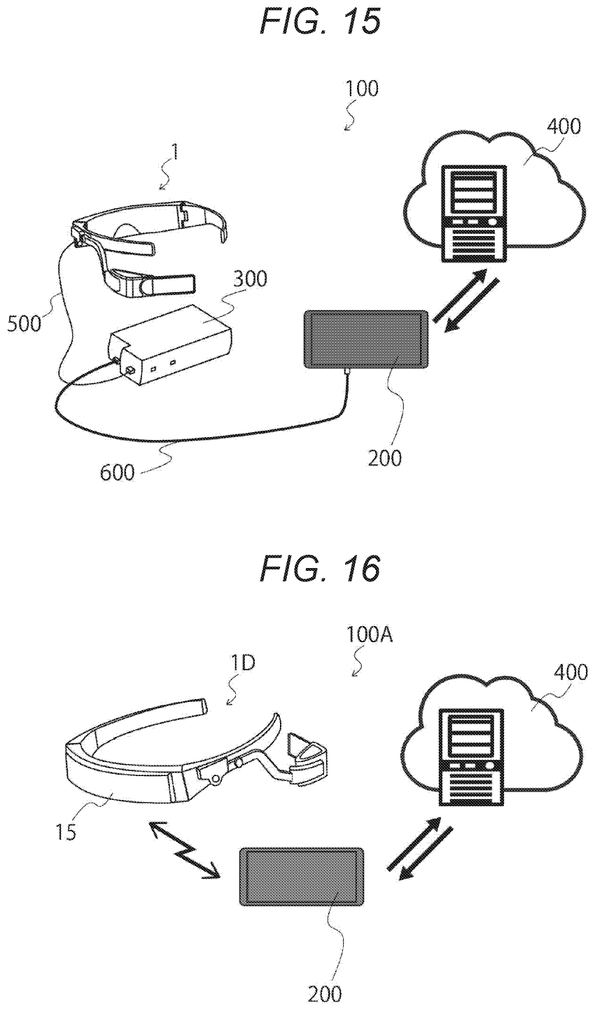

The character image display system of the present embodiment may have, for example, a configuration illustrated in FIG. 16. FIG. 16 is a view illustrating an example of an overall configuration of a character image display system 100A. A main difference of the character image display system 100A illustrated in FIG. 16 from the character image display system 100 illustrated in FIG. 15 is that a head-mounted display 1D is included and the electrical unit is not included. In the character image display system 100A illustrated in FIG. 16, the head-mounted display 1D includes an accommodation unit 15 at a position corresponding to the occipital region. The accommodation unit 15 accommodates hardware necessary for implementing the functions of the electrical unit described above, such as a control board and a power source. That is, the functions of the electrical unit described above are implemented by the control board, the power source, and the like accommodated in the accommodation unit 15 of the head-mounted display 1D. Furthermore, the accommodation unit 15 may accommodate the control unit described in the first embodiment described above.

Transmission and reception of data between the head-mounted display 1D and the mobile terminal 200 can be performed by wireless communication. An operation of the character image display system 100A is basically similar to that of the character image display system 100 described with reference to FIG. 15.

### 3. Modification

The head-mounted display of the present technology is not limited to the above-described configuration. Hereinafter, a first modification and a second modification of the head-mounted display of the present technology will be described with reference to the drawings.

### (1) First Modification

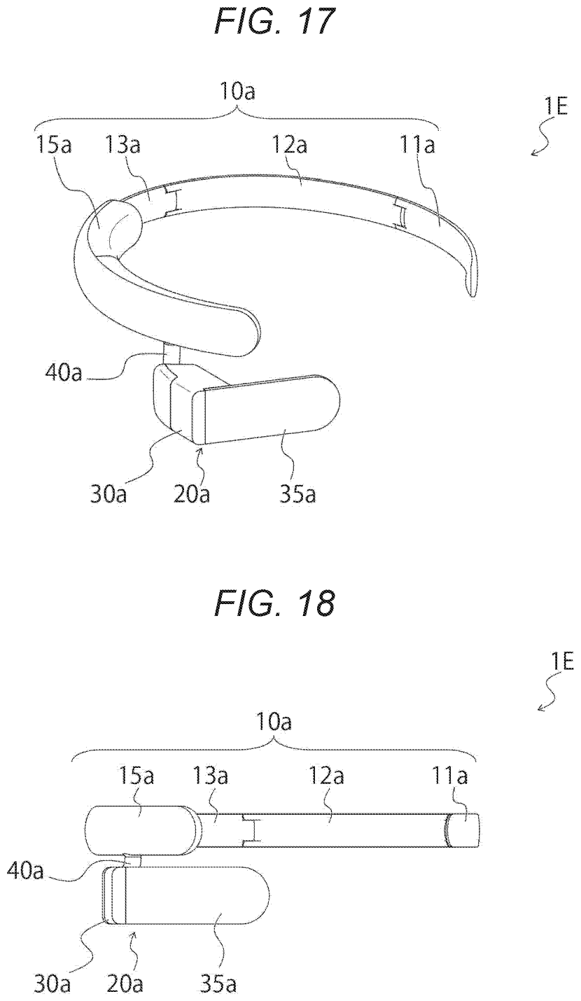

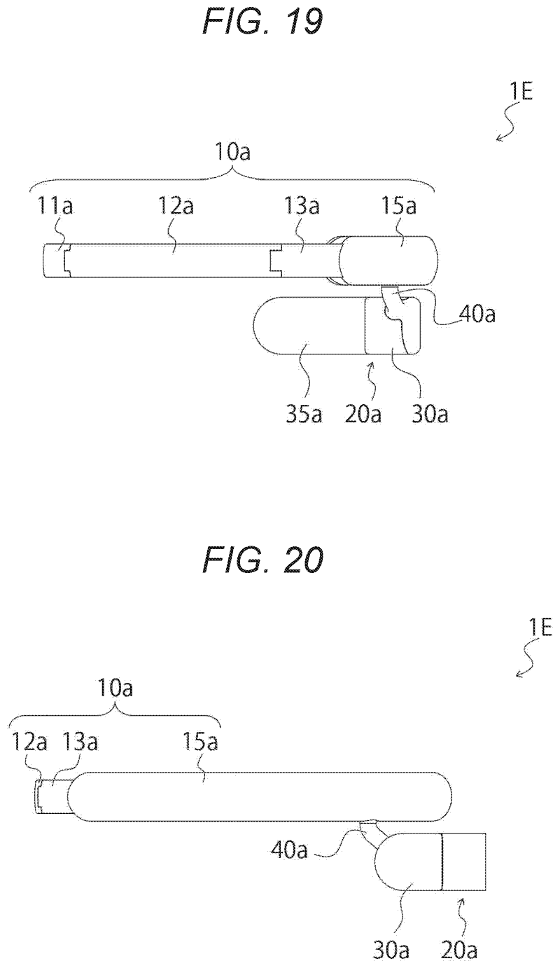

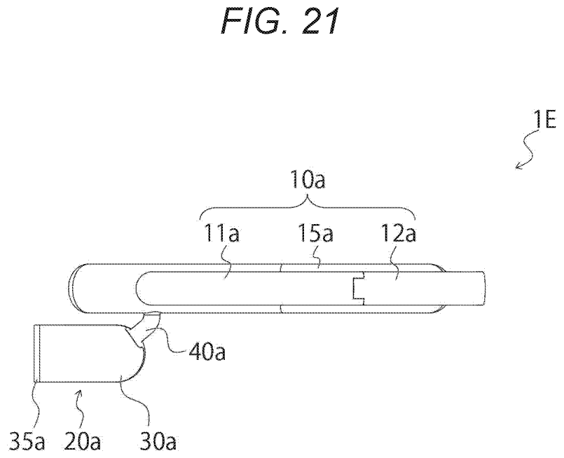

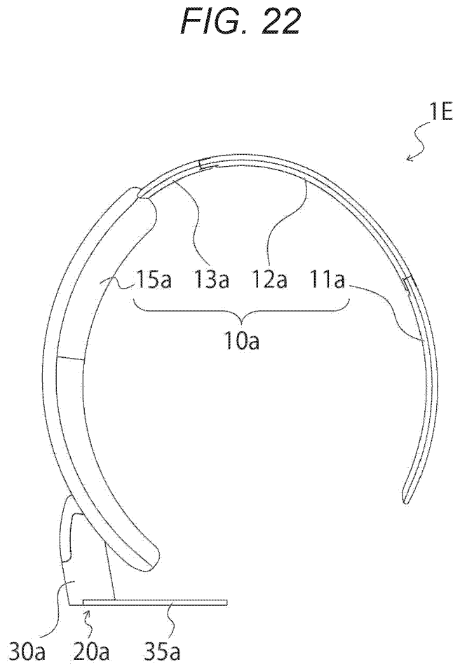

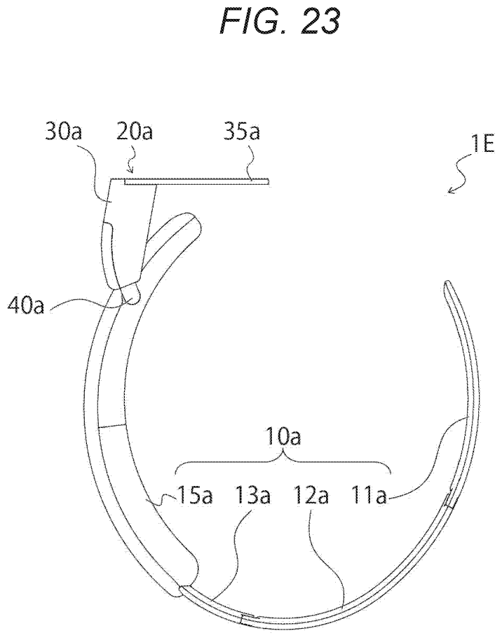

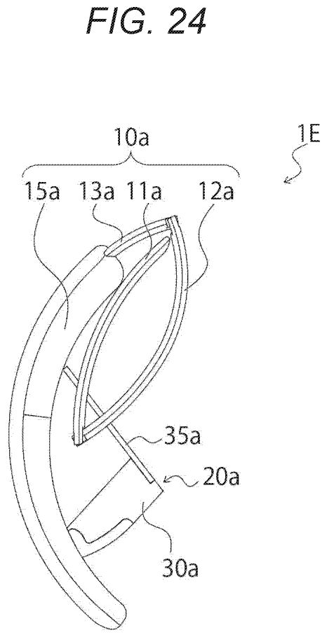

First, a monocular head-mounted display 1E of the first modification will be described with reference to FIGS. 17 to 24. FIG. 17 is a perspective view of the monocular head-mounted display 1E. FIG. 18 is a front view of the monocular head-mounted display 1E. FIG. 19 is a rear view of the monocular head-mounted display 1E. FIG. 20 is a left side view of the monocular head-mounted display 1E. FIG. 21 is a right side view of the monocular head-mounted display 1E. FIG. 22 is a plan view of the monocular head-mounted display 1E. FIG. 23 is a bottom view of the monocular head-mounted display 1E. FIG. 24 is a reference top view illustrating a state in which the monocular head-mounted display 1E is folded.

The head-mounted display 1E of the present modification includes a frame 10a, an image display device 20a, and a holding member 40a. The image display device 20a includes a housing 30a and a display unit 35a. Functions of the image display device 20a, the housing 30a, the display unit 35a, and the holding member 40a are similar to the functions of the image display device 20, the housing 30, the display unit 35, and the holding member 40 described in the first embodiment described above.

The frame 10a illustrated in FIGS. 17 to 24 includes an accommodation unit 15a, a first frame member 11a, a second frame member 12a, and a third frame member 13a. The accommodation unit 15a is provided at a position corresponding to the vicinity of the right temporal region of the user. The accommodation unit 15a can have, for example, a configuration and a function similar to those of the accommodation unit 15 described with reference to FIG. 16 in the second embodiment described above. The first frame member 11a, the second frame member 12a, and the third frame member 13a may be formed by flexible members. The first frame member 11a is provided at a position corresponding to the vicinity of the left temporal region of the user. The second frame member 12a is provided at a position corresponding to the vicinity of the occipital region of the user, and is bendably connected to the first frame member 11a. The third frame member 13a is provided between the second frame member 12a and the accommodation unit 15, and is bendably connected to both. By bending the connecting portions between the individual members of the frame 10a, the head-mounted display 1E is brought into a folded state as illustrated in FIG. 24.

### (2) Second Modification

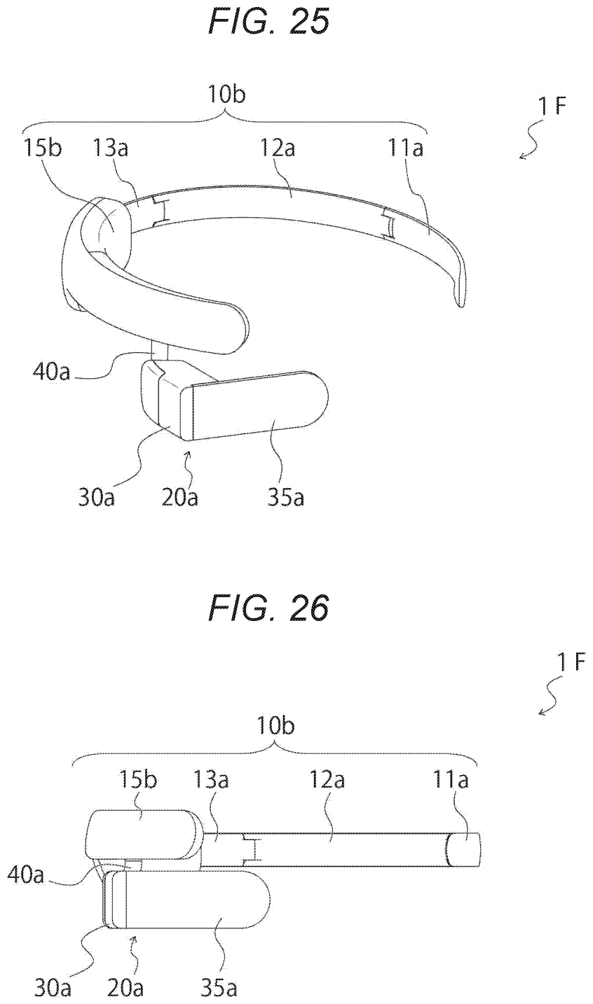

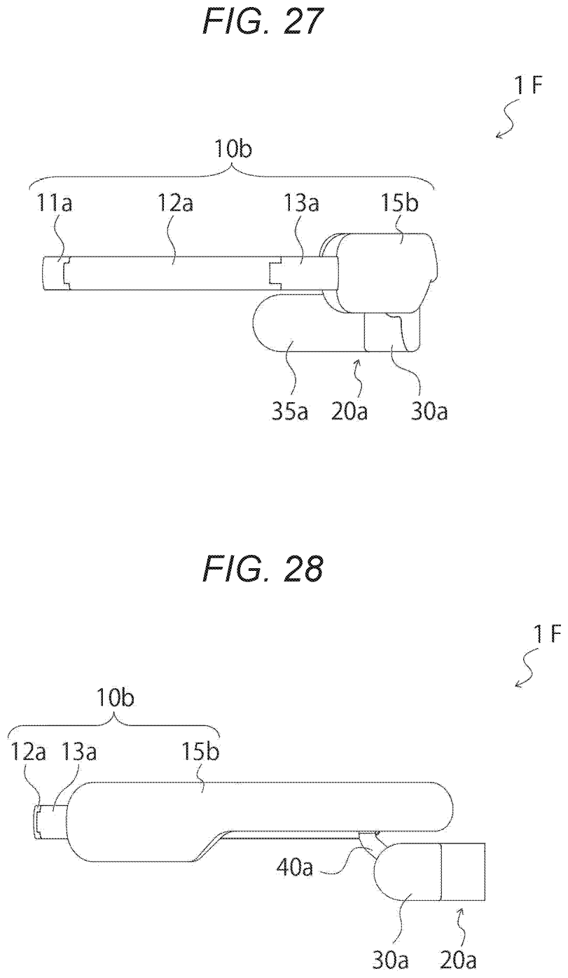

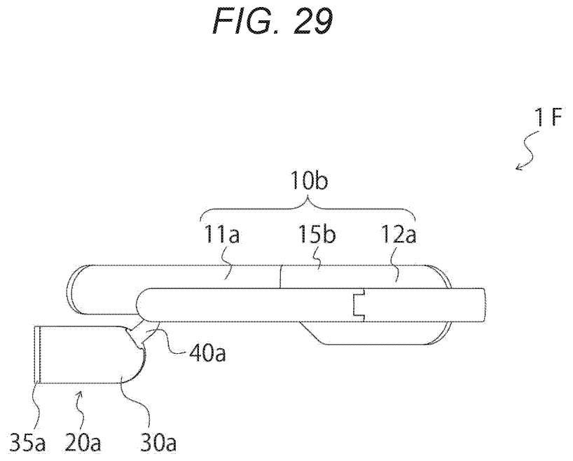

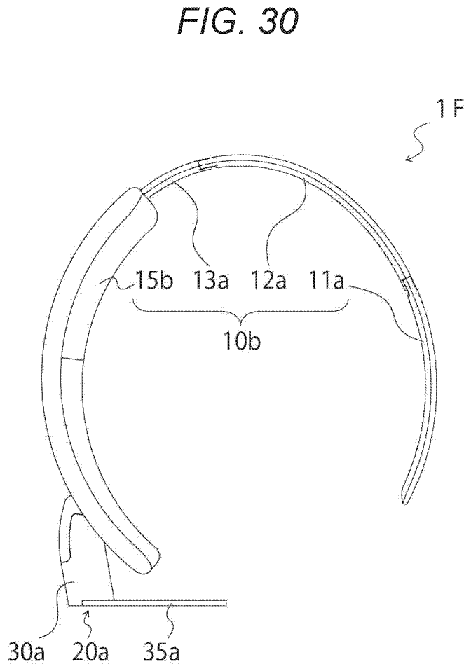

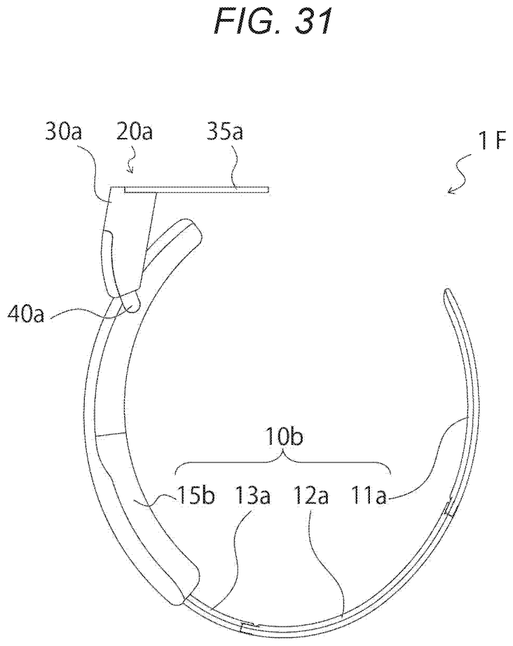

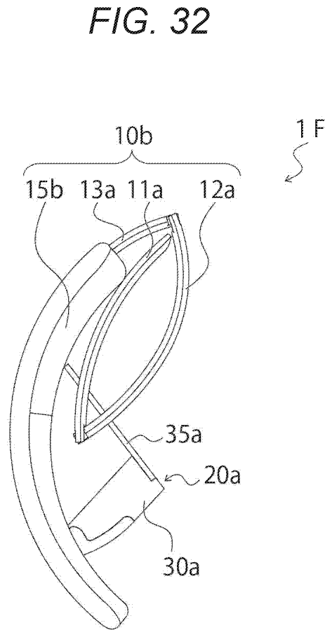

Next, a monocular head-mounted display 1F of the second modification will be described with reference to FIGS. 25 to 32. FIG. 25 is a perspective view of the monocular head-mounted display 1F. FIG. 26 is a front view of the monocular head-mounted display 1F. FIG. 27 is a rear view of the monocular head-mounted display 1F. FIG. 28 is a left side view of the monocular head-mounted display 1F. FIG. 29 is a right side view of the monocular head-mounted display 1F. FIG. 30 is a plan view of the monocular head-mounted display 1F. FIG. 31 is a bottom view of the monocular head-mounted display 1F. FIG. 32 is a reference top view illustrating a state in which the monocular head-mounted display 1F is folded.

The head-mounted display 1F of the present modification is different from the head-mounted display 1E of the first modification described above in that a shape of an accommodation unit 15b is different from a shape of the accommodation unit 15a described above. Details of components of the head-mounted display 1F of the present modification are as described in “(1) First modification” of 3. above except for the shape of the accommodation unit 15b. Therefore, in FIGS. 25 to 32 illustrating the head-mounted display 1F, the same reference numerals as those of the first modification described above are assigned to components to which the same description as that of the first modification described above applies.

Note that the present technology may also take the following configuration.

[1]

A head-mounted display including:
an optical plate arranged in front of an eyeball of a user and configured to cause image display light to reach the eyeball, in which
the optical plate is pivotable in a left-right direction about a center of the eyeball as a pivot center.
   [2]

The head-mounted display according to [1], in which the optical plate is further pivotable in an up-down direction about a center of the eyeball as a pivot center.

[3]

The head-mounted display according to [1] or [2], in which the optical plate is further movable in at least one direction among a left-right direction, an up-down direction, and a front-back direction with respect to the eyeball.

[4]

The head-mounted display according to any one of [1] to [3], further including:
a frame to be mounted on a head portion of the user, the frame having flexibility, in which
the frame is mounted in a circumferential direction of the head portion over a right temporal region, an occipital region, and a left temporal region, and at least one of a right frontal region or a left frontal region of the user.
   [5]

The head-mounted display according to any one of [1] to [4], in which
the image display light forms a character image corresponding to spoken voice of a speaker, and
the optical plate is configured to allow the user to visually recognize the speaker.
   [6]

The head-mounted display according to any one of [1] to [5], in which the head-mounted display is for hearing assistance.

[7]

The head-mounted display according to any one of [1] to [6], in which the head-mounted display is a monocular type.

### REFERENCE SIGNS LIST

1 Monocular head-mounted display
10 Frame
20 Image display device
30 Housing
35 Display unit
40 Holding member
50 Connecting portion
60 Mounting portion
70 Optical module
80 Image generation unit
90 Light guide plate
100 Character image display system

1. A head-mounted display comprising:
an optical plate arranged in front of an eyeball of a user and configured to cause image display light to reach the eyeball, wherein
the optical plate is pivotable in a left-right direction about a center of the eyeball as a pivot center.

2. The head-mounted display according to claim 1, wherein the optical plate is further pivotable in an up-down direction about a center of the eyeball as a pivot center.

3. The head-mounted display according to claim 1, wherein the optical plate is further movable in at least one direction among a left-right direction, an up-down direction, and a front-back direction with respect to the eyeball.

4. The head-mounted display according to claim 1, further comprising:
a frame to be mounted on a head portion of the user, the frame having flexibility, wherein
the frame is mounted in a circumferential direction of the head portion over a right temporal region, an occipital region, and a left temporal region, and at least one of a right frontal region or a left frontal region of the user.

5. The head-mounted display according to claim 1, wherein
the image display light forms a character image corresponding to spoken voice of a speaker, and
the optical plate is configured to allow the user to visually recognize the speaker.

6. The head-mounted display according to claim 1, wherein the head-mounted display is for hearing assistance.

7. The head-mounted display of claim 1, wherein the head-mounted display is a monocular type.
